(19) United States
(12) Patent Application Publication
(10) Pub. No.: US 2021/0216947 A1
(43) Pub. Date: Jul. 15, 2021

(54) PRODUCTION OF BATCHES OF PRODUCTS FOR PALLETIZING IN LAYERS

(71) Applicant: C.E.R.M.E.X. Constructions Etudes Et Researcherches De Materiels Pour L'Emballage D'Expedition, Corcelles- les-Citeaux (FR)

(72) Inventor: Gregory CHOPLIN, CORCELLES LES CITEAUX (FR)

(21) Appl. No.: 16/770,938

(22) PCT Filed: Dec. 5, 2018
(86) PCT No.: PCT/FR2018/053114

§ 371 Date: Jun. 8, 2020

(30) Foreign Application Priority Data
Dec. 6, 2017 (FR) 1761687

(51) Int. Cl. G06Q 10/08; B65G 47/244; B65G 47/26; B65G 47/82

(52) U.S. Cl. CPC G06Q 10/087; B65G 47/82; B65G 47/266; B65G 47/244

(57) ABSTRACT

The invention relates to a device for producing batches of products of a predefined configuration for palletizing in layers, said device comprising an upstream acceptance surface for the products, a downstream receiving surface for receiving the batches, and displacement means between the two surfaces formed by a series of rails and by a plurality of shuttles that can move independently of one another and that run on said rails, each shuttle configured to carry at least one product. This device is characterized in that the series of rails has at least one outbound rail configured to move the products from the upstream surface to the downstream surface, a return rail arranged beneath the outbound rail configured to return the empty shuttles to the upstream surface, and an upstream lifting rail and a downstream lifting rail configured to transfer the empty shuttles vertically between the outbound and return rails.

The present invention relates to the field of preparing products for shipment, and concerns firstly a specific device for producing batches of products, an installation incorporating such a device, and a method implementing this device.

In this field, handled products are usually cases, cardboard boxes, bundles and the like containing objects such as flasks and bottles. These objects are usually organized in a rectangular matrix, with or without staggering, and held together for example by a plastic film coating to form a bundle, with or without a cardboard tray base. These products are therefore obtained by means of a packaging step using individual finished products that involves forming groups in which the objects are held together, for example in bundles. These groups usually have a rectangular base with several objects arranged along each of two edges. Bundles can then be obtained using a bundler, in which a film is usually wrapped about each group of objects, before being shrunk in a heating kiln to hold the different objects in a single group together. On completion of this packaging step, the products are spaced apart from one another and flow in one or more lanes.

After this object packaging step in cases or bundles, the products thus obtained undergo a palletizing step in which the products are regrouped and possibly reoriented to form batches of a predetermined formation to form layers to be arranged on top of one another on pallets. The batches can notably be a row or partial row of a layer of products on the pallet.

U.S. Pat. No. 7,896,151 B2 notably describes the formation of rows of layers to be palletized. This document proposes arranging three conveyors one after the other, running at different speeds. The rows are formed from a single-lane flow of products in contact with one another. Groups of products are then obtained when moving from the first to the second conveyor by adjusting the speed difference therebetween to create a space between two successive products at predetermined locations. At this stage, the flow is then made up of isolated products and/or groups of products. A robot can then be used to move the products or groups of products transversely and/or to turn same about the vertical axis to form the rows.

Document US 2005/0246056 A1 relates to the formation of palletizing layers that also uses three conveyors arranged one after the other, running at different speeds. The products flow on the first conveyor in contact with one another in at least one lane. The second conveyor runs at a higher speed than the first conveyor in order to space the products apart from one another. The products are then grouped together or otherwise using a cyclical timer. Finally, a robot arranges the groups of products and/or the individual products to form a palletizable layer with a predetermined configuration.

DE 10219129 A1 proposes gripping means designed to selectively pick a group of products from a set of products and to rotate said products through 90°.

EP 2792623 A1 relates to the formation of a palletizable layer of products with a predetermined configuration by placing a manipulator between two conveyors arranged perpendicularly in relation to one another. The manipulator picks the packs flowing in a single lane from the first conveyor, then diverts and orients said packs in consideration of the predetermined formation, then conveys same to the second conveyor. A retaining element perpendicular to the conveyance direction of the second conveyor then enables the products to accumulate to form the desired palletizable layer.

EP 2185448 B1 describes a product conveyance system in which a gripping device can pick the products in order to turn said products, while moving said products in the conveyance direction such as to optimize conveyance throughput.

WO 2016/200751 describes a product conveyance system that uses suspended pushers that move the products along the surface of a conveyor, with suspended shuttles running along outbound and return slides, with a half-turn being executed at the ends of said slides by rotation about a semi-circular path portion.

Similar known solutions that use suspended pushers and rotational half-turns are described in documents EP 123886, WO 2014/195392, WO 2016/141022 and EP 2471728.

However, in each of the solutions described above, the formation of groups of products in a given configuration is done directly on the conveyors using gripping means. This generates friction between the products and the belt of the conveyor carrying said products, notably during translational and rotational movements of the products on the belt. This friction is even more problematic because it risks damaging the products and in particular ripping the film when the products are packaged in bundles.

Furthermore, since the formations of product batches described above is done on the belt conveyors carrying the products, the position of said batches is not precisely known. This makes it difficult to program gripping means to move or orient the target product precisely when said product reaches the gripping means. It is also difficult to identify issues in the event of malfunction of the device if the position of the products is not precisely known. In other words, such a system does not enable good traceability of the products.

Furthermore, the respective speed adjustment of two conveyors following one another in order to form product batches from a compact column is not instantaneous. In other words, if an instruction requires a conveyor to modulate the speed of said conveyor from speed x to speed y, the speed of said conveyor varies gradually before reaching speed y. This makes it difficult or impossible to precisely control the spacing between two products, one of which is being moved by a conveyor changing speed using such a device.

Another drawback of the above solutions lies in the fact that it is difficult for given gripping means to be used to turn both a single product and a group of several products simultaneously, for example a group of four products. Indeed, it is necessary to use a tool adapted to the dimensions of the element to be picked, and therefore potentially to change the tool if the elements to be picked are of different sizes. The solutions described above are therefore not very flexible.

Another drawback in the use of gripping means to rotate the products is that such a tool can cause impacts between the objects (bottles or flasks, for example) comprising the same product when picking a product or product group. Such impacts are not desirable since they cause noise and a risk of breakage, notably if the objects are made of glass. There is therefore a need to improve the current situation by at least partially contributing to resolving the problems identified above, and in particular to provide a system that is able to group together products in a wide range of predetermined configurations, to limit slipping between products and the support thereof, to generate as little noise as possible, and/or to precisely control the position of each product and the gap between two successive products.

The invention is therefore intended to propose a solution in which a single structure can be used for the entire configuration of a palletizable layer, and in which the formation of batches in a desired configuration is done by positive transfer of the packs, i.e. without any relative movement of the pack on the support thereof. Preferably, the invention makes it possible to control the position of each product individually during formation of a batch and therefore also the distance between two successive products, while minimizing impacts between the objects making up a single product and therefore the noise caused by such impacts.

To do so, the invention proposes making product batches of a predetermined configuration from a continuous feed of packs flowing in lanes using a system of shuttles running on a series of rails. Each shuttle is designed to receive at least one product or pack, is moveable in relation to the other shuttles, and is able to turn independently of the other shuttles.

The invention therefore relates to a device for producing batches of products from a plurality of products, said batches having a predefined configuration for palletizing in layers downstream, said device comprising an upstream acceptance surface on which the products are aligned in a lane in a first direction, a downstream receiving surface for receiving the batches, and displacement means between the two surfaces that is formed by a series of rails and by a plurality of shuttles that can move independently of one another and that run on said rails, each shuttle being designed to carry at least one product.

This device is characterized in that the series of rails has at least one outbound rail that is designed to move the products coming from the upstream surface to the downstream surface, a return rail arranged beneath the outbound rail that is designed to return the empty shuttles to the upstream surface, and an upstream lifting rail and a downstream lifting rail that are designed to transfer the empty shuttles between the outbound rail and the return rail.

Furthermore, such a device is characterized in that these lifting rails lie generally in a horizontal plane and are designed to effect at least one vertical translational movement between two positions, namely a high position and a low position; the high position entailing a lifting rail being arranged end-to-end with the outbound rail and the low position entailing a lifting rail being arranged end-to-end with the return rail.

Thus, the vertical movement of the lifting rails enables the shuttles to be transported, quickly and simply and in a small space, to and from the return and outbound rails, ensuring the continuity of the independent movements of the other shuttles along said return and outbound rails.

The invention also relates to an installation including this device, i.e. a device for producing batches of products.

This installation is characterized in that it also includes, mounted downstream of said production device, a device for forming palletizable layers from batches of products and a palletizing device for stacking the palletizable layers on a pallet.

The invention also relates to a method implemented by this device, specifically a method for producing at least one batch of products having a predetermined configuration from a plurality of products, for the purpose of downstream palletizing by layers.

This method is characterized in that it includes at least the following steps:

(i) transferring each product from the upstream acceptance surface onto a shuttle carried by an outbound rail, said transfer being effected in the first direction,

(ii) moving the shuttles along the at least one outbound rail to the downstream receiving surface, independently of one another, changing the relative position of the shuttles to adjust the distance between the products carried thereon and to create in the vicinity of said downstream receiving surface at least one batch of products with a predetermined configuration.

The invention can be better understood from the description below, which is based on possible embodiments, given by way of non-limiting examples and illustrated with reference to the attached figures, in which:

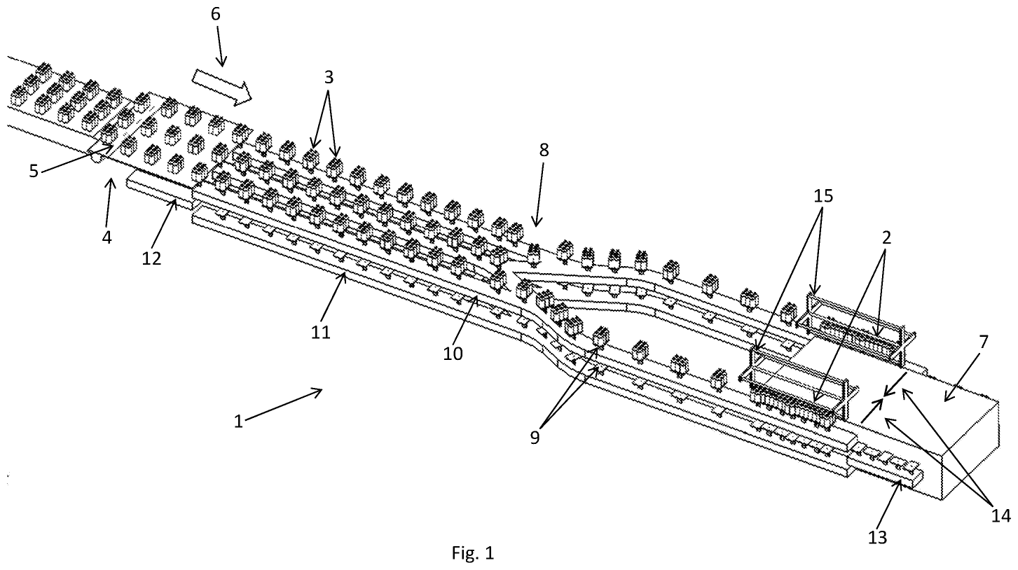

FIG. 1 is a perspective view of a production device according to one embodiment of the invention,

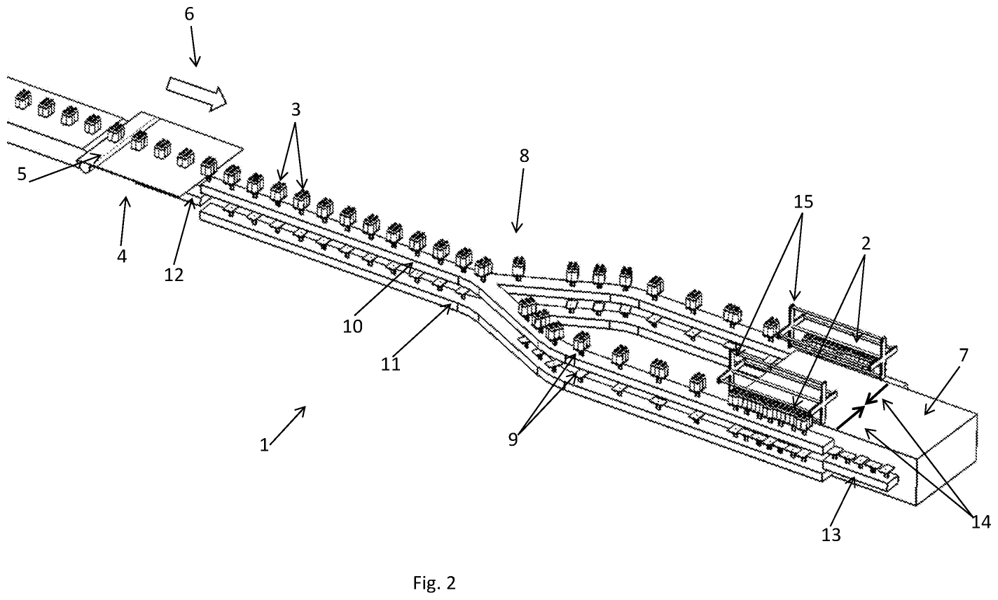

FIG. 2 is a perspective view of a production device according to another embodiment of the invention,

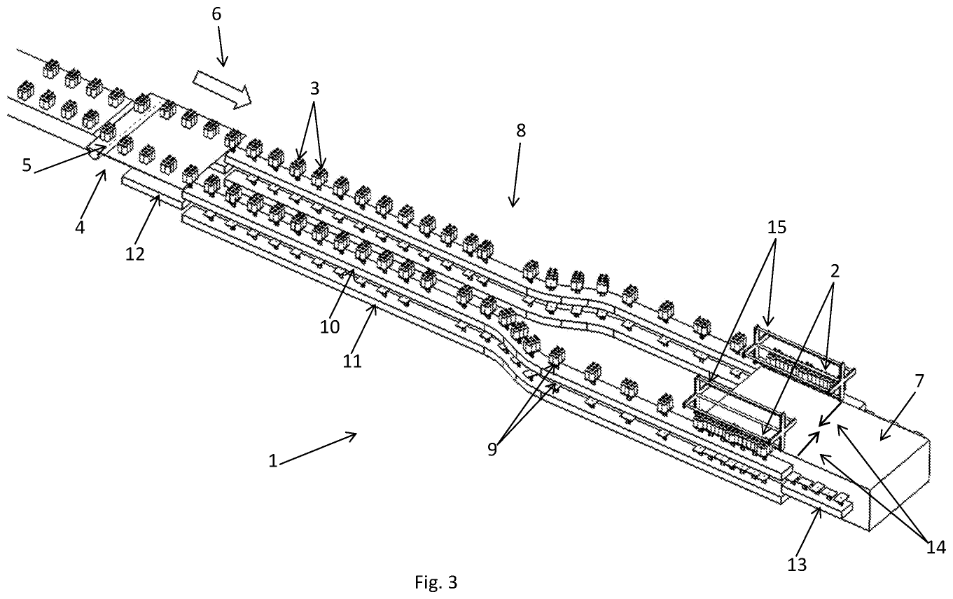

FIG. 3 is a perspective view of a production device according to yet another embodiment of the invention.

The invention therefore firstly relates to a device 1 for producing batches 2 of products 3 from a plurality of products 3, said batches 2 having a predetermined configuration, for the purpose of downstream palletizing in layers.

The products 3 are usually cases or bundles containing objects such as bottles, flasks, cans or other objects. These objects can be arranged in a matrix with or without staggering. A bundler or boxing machine is therefore provided upstream of the device 1 according to the invention to prepare the products 3. In this upstream machine, the objects are organized in a matrix and held together either by insertion into a case or by packaging in a shrink film to form a self-supporting bundle under the action of heat.

These products are then usually palletized in layers, i.e. the products 3 are loaded onto a pallet layer after layer. A layer of products is in principle a set of products 3 extending along two edges of the pallet and comprising only one product 3 in the vertical direction. For this purpose, a palletization pattern is provided to determine how to arranged the products 3 in each layer to ensure that the stacking of layers on a single pallet is as stable as possible.

In order to prepare the palletization of products 3 in layers, it is therefore necessary to group the products 3 into a predetermined configuration. The device according to the invention is specifically intended to form batches 2 of products 3 in a predetermined configuration.

In general, a batch 2 of products 3 is a row or partial row of a layer to be palletized, i.e. a single layer contains several batches 2 of products 3. A batch 2 of products 3 extends in a single direction, i.e. a batch is only one product wide. A batch 2 comprises at least two products 3 arranged side by side. The products 3 in a single batch are usually immediately beside one another. There may however be a small space between two products 3 arranged side by side in a single batch 2. This space is preferably smaller than the smallest dimension of the products 3, i.e. in principle smaller than the width of the base of the products 3.

The configuration of the batches 2 of products 3 is predetermined using the following parameters, which can therefore be different for different predetermined configurations:

the number of products 3 making up a single batch 2,

the spacing between two products 3 arranged side by side in a single batch, and

in certain embodiments, the orientation of the products 3.

A predetermined configuration is therefore characterized by a certain number of products 3 with a predetermined distance between the products 3, and possibly a specific orientation applied to each product 3, i.e. possibly an inclination in relation to at least one other product 3 for example a right angle or an angle of 180° about the vertical axis. This predetermined configuration for each batch 2 enables the stacking, in the palletizer located downstream of the device 1 according to the invention, of layers formed of several batches 2 on a pallet, these layers having a configuration corresponding to the configuration in the palletization pattern.

The configuration of each batch 2 is predetermined such as to form a layer of products 3 to be palletized, the arrangement of which corresponds to the arrangement provided for in the palletization pattern. As a result, each batch 2 can have a configuration identical to or different from the batch 2 formed immediately before or immediately after.

The production device 1 according to the invention comprises:

an upstream acceptance surface 4 on which the products 3 are aligned in lanes 5 in a first direction 6,

a downstream receiving surface 7 for receiving the batches 2, and

displacement means 8 between the two surfaces 4, 7 comprising a series of rails and by a plurality of shuttles 9 that can move independently of one another and that run on said rails, each shuttle 9 being designed to carry at least one product 3.

The products 3, for example coming from a boxing machine or a bundler, are conveyed on the upstream acceptance surface 4. This surface 4, which can be a conveyor or a slider bed, is usually arranged to extend the conveyor carrying the products 3 coming out of the machine upstream of the device 1. However, this surface 4 can also be the conveyor carrying the products 3 coming out of the machine upstream of the device 1.

The products 3 flow in a lane 5 on this surface 4 in a first direction 6 towards the displacement means 8. The number of lanes 5 of products 3 corresponds to the number of flow paths in the machine upstream of the device 1. The products 3 in a single lane are preferably spaced apart from one another, notably regularly spaced apart, i.e. the distance separating two consecutive products 3 is identical along the entire lane 5. However, the products 3 can also be immediately beside to one another, i.e. in contact, notably if the surface 4 is the acceptance surface of a conveyor.

The downstream receiving surface 7 can for example extend parallel or perpendicular to the first direction 6. This surface is designed to receive the batches 2 of products 3 that are prepared on the displacement means 8. This surface simultaneously receives the products 3 making up a single batch. In the remainder of the text, the term “downstream transfer zone” shall refer to the site of the device 1 according to the invention where the batches 2 of products 3 are transferred from the displacement means 8 to the downstream receiving surface 7.

The displacement means 8 are designed to transfer the products 3 coming from the upstream acceptance surface 4 to the downstream receiving surface 7. Furthermore, said means are designed to form the batches 2 of products 3. Thus, said means are designed to receive the products 3 brought by the upstream acceptance surface 4 and to move said products to the downstream receiving surface 7 while forming batches 2 of a predetermined configuration.

Preferably, the upstream acceptance surface 4, the displacement means 8 and the downstream receiving surface 7 lie in a horizontal plane.

In the remainder of the text, the term “upstream transfer zone” shall refer to the site of the device 1 according to the invention where the products 3 are transferred from the upstream acceptance surface 4 to the displacement means 8.

The displacement means 8 comprise several rails used to move the products 3. More specifically, shuttles 9 designed to transport the products 3 run on these rails, in order to convey the products 3 to the downstream receiving zone 7. Each shuttle 9 is designed to receive at least one product 3 on the upper surface thereof, and in particular each shuttle 9 is designed to receive a single product 3.

The shuttles 9 running on the rails can be moved independently of each other, which facilitates the formation of batches 2 of a predetermined configuration. Thus, the shuttles 9 of the device 1 are not linked mechanically to one another. In other words, it is possible to move two successive shuttles 9 towards or away from one another, for example to group the products 3 carried thereby to form a batch 2 of products 3 or to space apart two separate batches 2. In other words, the shuttles 9 can move separately from one another. To do so, the shuttles 9 are usually moved according to a linear motor principle. The stator function is in principle performed by the rails 10, 11, 12, 13 and the rotor function is in principle performed by the shuttles 9. Each rail 10, 11, 12, 13 can be formed by one or more stator segments.

Preferably, to facilitate formation of the batches 2 of products 3, the dimensions of the shuttles 9 in the horizontal plane are equal to or less than the length and the width of the base of the products 3. In other words, the shuttles 9 carrying the products 3 cannot be seen when the device 1 according to the invention is viewed from above. Indeed, if these size conditions are not observed, when two shuttles 9 are immediately beside to one another, the products 3 carried thereby cannot come into contact with one another.

The batches 2 are thus advantageously formed or spaced apart while considerably reducing the slipping of the products 3 on the related supports. Indeed, the batches 2 are formed directly by moving the supports of the products 3 and not by moving the products 3 on the related supports.

Using the linear motor principle ensures that the speed of each shuttle 9 is variable and the position of each shuttle 9 is controlled individually and known at all times. This ensures the traceability of the products 3 within the displacement means 8.

The production device 1 according to the invention is characterized in that the series of rails has at least one outbound rail 10 that is designed to move the products 3 coming from the upstream surface 4 to the downstream surface 7, a return rail 11 arranged beneath the outbound rail 10 that is designed to return the empty shuttles 9 to the upstream surface 4, and an upstream lifting rail 12 and a downstream lifting rail 13 that are designed to transfer the empty shuttles 9 between the outbound and return rails 10, 11.

Each of these rails 10, 11, 12, 13 usually lies within a horizontal plane. In principle, these rails 10, 11, 12, 13 have an upstream end and a downstream end, i.e. the rails do not form a closed flow loop. In particular, the upstream end of the outbound and return rails 10, 11 are in the upstream transfer zone. The downstream end of these rails 10, 11 is in the downstream transfer zone.

The outbound and return rails 10, 11 extend between the upstream acceptance surface 4 and the downstream receiving surface 7, notably from the upstream transfer zone to the downstream transfer zone. The outbound rail 10 is designed to convey the products 3 to the downstream receiving surface 7 while creating batches 2 of a predetermined configuration, and is therefore designed to run shuttles 9 bearing products 3 towards the downstream receiving surface 7. The return rail 11 is designed to return the empty shuttles 9 to the upstream acceptance surface 4 to receive new products 3 in the upstream transfer zone. Consequently, the shuttles 9 run empty on the return rail 11.

The return rail 11 usually lies in a horizontal plane positioned in principle beneath the plane containing the outbound rail 10. In general, when viewed from above, only the outbound rail 10 can be seen at least at the upstream and downstream ends thereof, and preferably only the outbound rail 10 can be seen along the entire length thereof. In other words, the outbound and return rails 10, 11 are usually superposed at least at the ends thereof, and preferably along the entire length thereof.

The displacement means 8 thus include two lifting rails 12 and 13 that are used to transfer the shuttles 9 between the outbound and return rails 10, 11. In principle, said rails therefore transport the shuttles with no products 3.

These lifting rails 12, 13 usually lie in a horizontal plane and are able to make at least one vertical translational movement. These rails 12, 13 can notably be positioned in two positions referred to as the high position and the low position. In the high position, a lifting rail 12, 13 extends the outbound rail 10 and is arranged end-to-end with said outbound rail 10, thereby enabling the shuttles 9 to run between the outbound rail 10 and the lifting rail 12, 13. In the low position, a lifting rail 12, 13 extends the return rail 11 and is arranged end-to-end with said return rail 11, thereby enabling the shuttles 9 to run between the return rail 11 and the lifting rail 12, 13. Arranging the lifting rails 12, 13 end-to-end with the outbound and return rails 10, 11 involves aligning the respective ends thereof to ensure the continuity of the rails and of the running path of the shuttles in the high and low positions of said lifting rails 12, 13. The lifting rails 12 and 13 are independently controllable, which means that said rails are not necessarily in the high position and/or the low position simultaneously.

The upstream lifting rail 12 is more specifically designed to transfer the empty shuttles 9 from the return rail 11 to the outbound rail 10. In other words, said rail is designed to lift the shuttles 9 to enable said shuttles to receive the products 3 coming from the upstream acceptance surface 4. This rail 12 is usually positioned directly upstream of the upstream transfer zone.

The downstream lifting rail 13 is more specifically designed to transfer the empty shuttles 9 from the outbound rail 10 to the return rail 11. In other words, said rail is designed to lower the shuttles 9 following transfer of a batch 2 to the downstream receiving surface 7 to enable said shuttles to return to the upstream acceptance surface 4. This rail 13 is usually positioned directly downstream of the downstream transfer zone.

Such a configuration of the displacement means 8 is particularly advantageous since the superposition of the rails 10, 11 occupies limited floor space and enables an operator to intervene easily (notably compared to displacement means forming a closed running loop) without thereby reducing throughput.

According to an additional possible feature of the device 1, said shuttles 9 comprise a lower portion that cooperates with a rail 10, 11, 12, 13 and an upper portion that is designed to carry at least one product 3, in which the upper portions of said shuttles 9 can be rotated about the vertical axis.

Each shuttle 9 therefore has two portions:

a lower portion that is rigidly connected to a rail 10, 11, 12, 13 and that enables the shuttles 9 to run on the rail 10, 11, 12, 13, and

an upper portion, also referred to as a tray, that is free to rotate about a vertical axis and that can carry at least one product 3, preferably a single product 3.

Thus, the upper portion of a shuttle 9 can turn in relation to the lower portion thereof about a vertical axis, thereby causing the product 3 carried thereon to rotate. This advantageously enables a wider variety of configurations of batches 2 and therefore of palletization patterns.

If the trays of the shuttles 9 can turn, the following elements can then differ between batches 2:

the number of products 3 making up a single batch 2,

the spacing between two products 3 arranged side by side in a single batch, and/or

the orientation of the products 3.

Preferably, the upper portions of the shuttles 9 are designed to be rotated in this manner independently of one another. Thus, a single batch 2 of products 3 can for example include a product 3 that has been rotated and other products 3 that have not been rotated in the same way. Preferably, the upper portions of the shuttles 9 can be rotated through an angle of 90° or 180°, in particular 90°.

This rotational movement can be made both if the shuttles 9 are stopped and if the shuttles are moving along a rail 10, 11, 12, 13. Preferably, the trays of the shuttles 9 undergo such a rotational movement when the shuttles 9 move on a rail 10, 11, 12, 13 to work concurrently.

The rotation of the trays of the shuttles 9 can for example be caused by a rotation system carried on the shuttle 9 or by an element arranged outside the shuttles 9.

Thus, according to another additional possible feature, at least one shuttle 9 carries a rotation system enabling the upper portion thereof to rotate about the vertical axis.

Preferably, each shuttle 9 carries a rotation system enabling the upper portion of each shuttle 9 to rotate about the vertical axis. Thus, the trays of the shuttles 9 incorporating such a rotation system can turn about the vertical axis, preferably through an angle of 90°.

The trays of the shuttles can turn independently of each other, or otherwise, to form batches 2 leading to the formation of layers of products 3 with a configuration according to the predetermined palletization pattern.

According to another possible additional feature, the device 1 also includes at least one element arranged outside said shuttles 9, this element being designed to rotate the upper portion of at least one shuttle 9 about the vertical axis.

Preferably, such an element can rotate the tray of each shuttle 9 about the vertical axis.

The device 1 can notably include two such elements, specifically:

a first element designed to rotate at least one tray when the shuttle 9 carrying said tray is running on the outbound rail 10 to enable the formation of the desired batch, and

a second element designed to rotate the tray in the opposite direction to return said tray to the initial position thereof when the shuttle 9 carrying said tray is running on the return rail 11 or on one of the lifting rails 12, 13.

According to a first variant, such an element can for example be a stop or a cam, notably retractable. In working position, such a stop or cam is on the path of the trays of the shuttles 9 running on the rail 10, 11, 12, 13 such as to turn said trays about the vertical axis when the trays come into contact with the stop or cam. In idle position, such a stop or cam is arranged such that the trays cannot come into contact therewith. Where the external element is a stop or cam, the device must have at least two of the elements described above, the first element being used to change the orientation of the desired products 3 when creating batches 2, and the second element enabling the shuttles 9 that have been rotated on the outbound rail 10 to return to the initial orientation thereof before loading new products 3.

According to this variant, at least one pin is arranged beneath the tray of the rotating shuttles 9 and is offset in relation to the rotary shaft of the tray. The at least one pin can then hit a stop or be guided by a cam along a path, such as to cause the tray to which said pin is attached to rotate. A stop can for example be a bar extending along the vertical axis, the top end of which is level with the trays, and in particular with the pin or pins, but is offset in relation to the lower portion of the shuttles so as not to interfere with the running thereof on the rail 10, 11, 12, 13. The stop can also be a bar extending along the horizontal axis, the end of which closest to the trays comes into contact therewith without coming into contact with the lower portion of the shuttles. If a pin of the tray comes into contact with the stop, the shuttle continues to run on the rail, while the stop remains static through the duration of the contact. The rotation of the tray is then caused by the center of gravity of the stop being outside the vertical plane passing through the center of gravity of the tray, which is parallel to the running direction of the shuttle 9 at the time the shuttle 9 comes into contact with the stop.

Such a stop or cam can be retractable so as to only turn some trays as a function of the desired configuration for the batch 2 to be formed, and to only turn the shuttles 9 that have been used to change the orientation of the products carried thereby to return said shuttles to the original orientation thereof.

In idle position, the stop or cam is arranged so as not to come into contact with the pin or pins carried by the shuttles 9. To pivot a product 3, a command can for example actuate a cylinder, which moves the stop or the cam into contact with a pin of the tray to be rotated. Preferably, where such a stop or cam system is used to rotate the trays, the trays are prevented from rotating except for the precise moment at which the trays are pivoted, if desired. This helps to prevent the trays from turning randomly, for example as a result of running, notably over a curved portion of a rail 10, 11, 12, 13.

According to a second variant, this element can for example be an attached shuttle linked to the rotary shaft of the tray of a shuttle 9 to be rotated, also running on the rail 10, 11, 12, 13. These two shuttles can be attached by means of a system enabling the tray to be rotated when the shuttle 9 and the attached shuttle linked to the shuttle 9 move towards or away from one another, the attached shuttle being in front of or behind the shuttle 9 to which it is attached. There is therefore no shuttle 9 between an attached shuttle and the shuttle 9 with which it is associated. Such an attached shuttle does not in principle have a tray, i.e. it is not intended to carry a product 3.

By way of example, the tray of a shuttle 9 and the attached shuttle to which same is coupled can linked in the following ways. The shuttles can be linked by a linkage system, i.e. a bar attached at one end to the attached shuttle and at the other end at the rotary shaft of the tray, including at least one pivoting link or ball joint. Such a system must he offset in relation to the rotary shaft of the tray of the shuttle 9.

Another option is to attach one end of a bar to the attached shuttle, in which the other end has a rack gear that cooperates with a gear wheel placed on the shuttle 9. More specifically, such a gear wheel is carried by the rotary shaft of the tray of the shuttle 9 and is rigidly connected to said shaft. The rotation of such a wheel then drives the tray carried by said rotating shaft.

When the tray carried by a shuttle 9 is not supposed to turn, the shuttle 9 and the attached shuttle linked thereto run on the rail 10, 11, 12, 13 at a constant distance during the movement thereof. To turn the tray 10, the distance between the two shuttles need simply be modified. In other words, the two shuttles have to be moved towards or away from one another by increasing or decreasing the speed of one or of the other.

To enable two products 3 carried by two successive shuttles 9, each shuttle being linked to an attached shuttle, to come into contact to form a batch 2, the attached shuttles and the lower portions of the shuttles 9 are smaller than the trays of the shuttles 9. Thus, the dimensions of the lower portions of the shuttles 9 and of the attached shuttles are such that each attached shuttle can preferably be:

either entirely beneath the tray of the shuttle 9 to which said attached shuttle is linked,

or partially beneath the tray of the shuttle 9 to which said attached shuttle is linked, so that the portion of the attached shuttle that is not beneath the tray of the shuttle 9 to which said attached shuttle is linked is beneath the tray of the following shuttle 9.

According to another possible additional feature, the series of rails is formed by a plurality of outbound rails 10, independent or otherwise, and of return rails 11, in which the architecture of the outbound and return rails 10, 11 is similar and there are as many upstream lifting rails 12 as outbound flow paths at the upstream end of the displacement means 8, and as many downstream lifting rails 13 as outbound flow paths at the downstream end of the displacement means 8.

The option of having a plurality of outbound rails 10 is particularly useful:

(i) if the machine located upstream of the device 1, for example a bundler, outputs the products 3 in a multi-lane flow. In this case, the flow of products 3 conveyed to the displacement means 8 has several lanes 5 of products 3 that are parallel to one another, usually from two to five lanes 5, preferably two or three lanes 5. In this case, each outbound rail 10 can handle the products 3 coming from one lane 5, and

(ii) for transferring the batches 2 of products 3 to several different downstream receiving surfaces 7 so as to form several layers simultaneously, and/or for simultaneously transferring two batches 2 to a single downstream receiving surface 7 in order to form a layer more quickly.

These rails 10 can be independent, i.e. separate from one another along the entire length of the displacement means 8 such that the shuttles 9 cannot move from one rail 10 to another. In other words, in this case, there are no switches enabling several rails to join together or for one rail to split into several rails. These rails 10 can also be linked to one another using switching means. Thus, the number of outbound rails 10 can vary along the length of the displacement means 8.

In the remainder of the text, for each category of rail (outbound rail 10, return rail 11, upstream lifting rail 12 or downstream lifting rail 13), one rail is considered to correspond to one flow path. Thus, by way of example, a single outbound rail 10 corresponds to a single outbound flow path, while two independent outbound rails 10 correspond to two outbound flow paths. Displacement means 8 including two outbound rails 10 on the upstream portion that subsequently join together into a single outbound rail 10 are therefore displacement means including two outbound flow paths that join together into a single outbound flow path.

Where the displacement means 8 include switches, the shuttles 9 are synchronized to prevent collisions between shuttles.

Thus, the displacement means 8 can for example include two separate outbound rails 10 along the entire length of the displacement means 8, as shown in FIG. 3. The displacement means 8 can for example have a single outbound rail 10 in the upstream portion thereof, that subsequently splits into two rails 10, as shown in FIG. 2. Another option is displacement means 8 including several outbound rails 10 in the upstream portion thereof, for example three, that join together to form fewer outbound rails 10, for example two, as shown in FIG. 1.

As indicated above, the architecture of the outbound and return rails 10, 11 is identical. In other words, there are the same number of outbound rails 10 as return rails 11. More specifically, there is the same number of outbound and return flow paths at the downstream end as at the upstream end of the displacement means 8. Furthermore, at least at the upstream and downstream ends of the displacement means 8, a return rail 11 is preferably arranged beneath each outbound rail 10, i.e. offset vertically downwards in relation to each outbound rail 10. In other words, only the outbound rails 10 can be seen from above, at least at the upstream and downstream ends of the displacement means 8, and preferably along the entire length of the displacement means 8. With such a configuration, the lifting rails 12, 13 only have to make a vertical movement to transfer the shuttles between an outbound rail 10 and a return rail 11.

Each upstream lifting rail 12 is associated with an outbound rail 10 and with a return rail 11 at the upstream end of the displacement means 8. More specifically, said lifting rail is associated with a pair of rails 10, 11 arranged one above the other. There are therefore as many upstream lifting rails 12 as outbound rails 10 and as return rails 11 at the upstream end of the displacement means 8. The same is true for the downstream lifting rails 13 in relation to the outbound and return rails 10, 11 at the upstream end of the displacement means 8. Preferably, the lifting rails 12, 13 do not have switches. Thus, where there are several lifting rails 12 or 13, said rails are independent of one another.

According to another possible additional feature, the series of rails is such that there are:

between one and five, and notably between one and three, outbound flow paths at the upstream end of the displacement means 8,

between one and two outbound flow paths at the downstream end of the displacement means 8,

wherein there is the same number of outbound and return flow paths at each of the downstream and upstream ends of the displacement means 8.

There are usually as many outbound flow paths, and therefore outbound rails 10, at the upstream end of the displacement means 8 as lanes 5 of products 3 flowing on the upstream acceptance surface 4. The same is true of the return flow paths.

At the upstream end of the outbound and return rails 10, 11, i.e. in the upstream transfer zone, the rails 10, 11 preferably extend in the first direction 6. Indeed, in this case, the shuttles 9 can run on the outbound rail or rails 10 when receiving a product 3, the lane or lanes of products 3 being arranged in this direction on the upstream acceptance surface 4. This advantageously ensures a high throughput. Preferably, the shuttles 9 run at the same speed as the products 3 on the upstream acceptance surface 4.

Alternatively, where there is only one outbound rail 10 at the upstream end of the displacement means (and therefore, most commonly, where there is only one lane 5), the rails 10, 11 can run along the downstream edge of the upstream acceptance surface 4, i.e. perpendicular to the first direction 6. In this case, the transfer of products 3 to the shuttles 9 is in principle performed when the shuttles 9 are stopped on the outbound rail 10.

In general, and more so where the upstream end of the rails 10, 11 extend in the first direction 6, the at least one outbound rail 10 is positioned slightly beneath the horizontal plane defined by the upstream acceptance surface 4. More specifically, the upper surface of the shuttles 9 running on this rail 10 is beneath this plane, thereby enabling the shuttles 9 to run on the upstream lifting rail 12 that is in principle beneath the acceptance surface 4, when this rail 12 is in the high position. Consequently, the shuttles 9 can move from the rail 12 to the rail 10. As a result of this, it is particularly advantageous for the upstream acceptance surface 4 to be carried by a slider bed. Indeed, such a bed is thin, which enables the height difference between the upper surface of the shuttles 9 and the upstream acceptance surface 4 to be small to limit the vertical impact of the products 3 being transferred to the shuttles 9.

According to another possible additional feature, said device also includes an upstream transverse pusher that is designed to transfer the products 3 in the first direction 6 from the upstream acceptance surface 4 onto the shuttles 9 of the at least one outbound rail 10.

Such a pusher is particularly suitable where the acceptance surface 4 is a slider bed. Said pusher extends perpendicularly to the first direction 6 and pushes the products 3, preferably one by one, from behind, parallel to the first direction 6. Where the products 3 are conveyed in a multi-lane flow, there can be as many upstream pushers as lanes 5, or there may be a single pusher simultaneously pushing a product 3 in each lane 5. At the upstream transverse pusher, the device 1 can include a sensor to synchronize the shuttles 9 with the arrival of the products 3.

Where the acceptance surface 4 is the upper surface of a slider bed, the upstream transverse pusher is arranged on the upstream portion of this bed in the direction 6 and pushes the products 3 onto the shuttles 9. Where the acceptance surface 4 is the upper surface of a conveyor, referred to as the upstream conveyor, the upstream pusher is placed at the downstream end of this conveyor.

Such a pusher can notably be a sweep pusher or a rotary pusher. Preferably, the upstream transverse pusher is a cycler. Where the upstream transverse pusher is a cycler, the bar of the cycler is synchronized with the at least one product 3 to be pushed so that said bar only comes into contact with the desired product 3, and with a force that pushes said product 3 but that does not tip said product.

According to another possible additional feature, the upstream acceptance surface 4 is carried by an upstream conveyor extending in the first direction 6, and the upper surface of said shuttles 9 running on the at least one outbound rail 10 is offset vertically downwards in relation to the surface 4 carrying the products 3 such that the products 3 drop onto the shuttles 9 as a result of the movement of said upstream conveyor.

The products 3 are then transferred to the shuttles 9 by the movement of the upstream conveyor bearing the upstream acceptance surface 4 in the first direction 6 driving the products 3 on the shuttles 9.

When a shuttle 9 receives a product 3, said shuttle is extending the upstream conveyor bearing the upstream acceptance surface 4 in the direction 6, at a lower level in relation to the upstream conveyor. In other words, the horizontal surface of the tray thereof that accepts the product 3 is lower than the surface 4 carrying the products 3 before the products are transferred. Preferably, the height difference between these two surfaces is less than the height of the products 3 to be transferred, so as to minimize the risk of fall during transfer. The roller diameter of this upstream conveyor is therefore preferably small, and notably less than the height of the products 3.

A sensor can for example be arranged at the end of the upstream conveyor to synchronize the shuttles 9 with the products 3 so that each shuttle 9 can receive a product 3.

An alternative to this solution is to position retaining means provided with a sensor at the end of the upstream conveyor to reference the products 3.

Once the products 3 have been transferred to the shuttles 9, the batches 2 of products 3 of a predetermined configuration are formed along the outbound rail or rails 10 by moving two shuttles 9 towards or away from each other, each shuttle carrying a product 3, and possibly by rotating at least an upper portion of a shuttle 9 carrying a product 3. On the rail 10, 11, two successive batches 2 are separated by a distance greater than the distance between two successive products 3 of a given batch 2. Indeed, in general, the products 3 of a given batch 2 are preferably immediately beside one another, but can be spaced apart by a distance conventionally less than the length or the width of the base of the product 3. Conversely, two successive batches 2 are spaced apart by a distance conventionally greater than the width or the length of the base of the product 3.

Once the batches 2 of products 3 have been formed and are close to the downstream receiving surface 7, i.e. in the downstream transfer zone, said batches are transferred to the downstream receiving surface 7.

In the downstream transfer zone, the at least one outbound rail 10 is usually arranged along the downstream receiving surface 7, and more specifically along one of the edges of the downstream receiving surface 7 so that the batches 2 are transferred from the shuttles 9 to the downstream receiving surface 7 in a second direction 14, which is perpendicular to the running direction of the shuttles 9 on the at least one outbound rail 10 in this zone. The second direction 14 is preferably parallel or perpendicular to the first direction 6.

Where there are two outbound rails 10 in the downstream transfer zone, said rails are preferably arranged along two opposite edges of the downstream receiving surface 7, as shown in FIGS. 1 to 3.

During transfer, the batches 2 are preferably stationary on the outbound rail 10, i.e. the shuttles 9 carrying the products 3 making up a given batch 2 are stopped on the outbound rail 10.

In relation to the trays of the shuttles 9, the downstream receiving surface 7, which usually lies in a horizontal plane, is in principle at the same height or offset vertically downwards in order to facilitate reception of the batches 2. However, in some embodiments detailed below, it is possible for the downstream receiving surface 7 to be offset vertically upwards.

According to another possible additional feature, said device 1 also includes gripping means that are designed to pick the batches 2 of products 3 on the shuttles 9 of the at least one outbound rail 10 and to transfer same to the downstream receiving surface 7 in a second direction 14 perpendicular to the running direction of the shuttles 9 at this location.

Such gripping means can notably be a claw of a robot. These gripping means simultaneously pick the products 3 from a given batch 2 before lifting, moving and placing said products on the downstream receiving surface 7. The gripping means perform this operation batch 2 after batch 2 so as to transfer each batch 2 to the downstream receiving surface 7 one after the other.

According to this specific embodiment, the horizontal plane containing the downstream receiving surface 7 can be the same as the horizontal plane defined by the upper surfaces of the shuttles 9 carrying the batch or batches 2 to be transferred, offset upwards or downwards.

According to another possible additional feature, the device 1 also includes a downstream transverse pusher 15 that is designed to transfer the batches 2 of products 3 on the shuttles 9 of the at least one outbound rail 10 to the downstream receiving surface 7 in a second direction 14 perpendicular to the running direction of the shuttles 9 at this location.

Such a downstream transverse pusher 15 can be similar to the upstream transverse pusher described above. The pusher simultaneously pushes the products 3 making up a given batch 2 from behind from the shuttles 9 to the downstream receiving surface 7. The pusher performs this operation batch 2 after batch 2 so as to transfer each batch 2 to the downstream receiving surface 7 one after the other.

Such a pusher 15 can notably be a sweep pusher or a rotary pusher. Preferably, the downstream transverse pusher is a cycler.

According to another possible additional feature, the downstream receiving surface 7 is carried by a downstream conveyor that is designed to move the batches 2 of products 3 in a third direction.

This downstream conveyor therefore extends in a third direction and the upper surface thereof, which bears the batches 2, is the downstream receiving surface 7.

The third direction is preferably parallel or perpendicular to the first direction 6. Preferably, the third direction is parallel or perpendicular to the transfer direction 14 of the batches 2 of products 3 from the shuttle 9 onto the downstream receiving surface 7.

Where the third direction is parallel to the second direction 14, there is preferably a single outbound rail 10 in the downstream transfer zone running alongside the input of the downstream conveyor. In other words, the rail 10 is perpendicular to the third direction in the downstream transfer zone. In this case, the batches 2 of products on the downstream conveyor extend across the third direction.

Where the third direction is perpendicular to the second direction 14, there are preferably one or two outbound rails 10 in the downstream transfer zone. If there is a single outbound rail 10, said rail runs alongside one of the sides of the downstream conveyor, and if there are two rails, each of said rails runs alongside one of the sides of the downstream conveyor. In both cases, the rail 10 is parallel to the third direction in the downstream transfer zone.

The batches 2 of products 3 on the downstream conveyor then extend in the third direction. For this purpose, the downstream conveyor is usually a distribution conveyor with rollers oriented perpendicular to the third direction. This enables the products 3 to be transferred easily to the downstream conveyor perpendicular to the running direction thereof.

As indicated above, where there are two outbound rails 10 in the downstream transfer zone, two batches 2 can be transferred simultaneously to the downstream conveyor perpendicular to the third direction.

The invention also relates to an installation including a device 1 for producing batches (2) of products (3), as defined above, characterized in that it also includes, mounted downstream of said production device 1, a device for forming palletizable layers from batches 2 of products 3 and a palletizing device for stacking the palletizable layers on a pallet.

The layer formation device can simply be a vertical retaining surface arranged at the output of the downstream conveyor (where the downstream receiving surface 7 is carried by such a conveyor) perpendicular to the third direction. Such a surface forms a stop for the products 3 coming into contact therewith. This surface therefore usually extends parallel to the second direction 14 where there are two rails 10 at the downstream end of the displacement means 8, and usually perpendicular to the second direction 14 where there is one rail 10 at the downstream end of the displacement means 8.

Where the batches 2 of products extend across the third direction, such a surface advantageously enables the batch 2 furthest downstream to be retained, the following batch 2 to be retained against the batch 2 furthest downstream, and so forth. The batches 2 therefore accumulate against one another until a layer of products 3 to be palletized is obtained.

Where the batches 2 of products 3 extend in the third direction, such a surface advantageously enables the product 3 furthest downstream in each batch 2 comprising the batch to be palletized to be retained. The batches 2 comprising a single layer are then side by side, and the product 3 furthest downstream in each lot 2 is in contact with the retaining surface.

The layer formation device can also have gripping means such as a claw enabling the products 3 from a given layer to be drawn together against one another. More specifically, several batches 2 on the downstream receiving surface 7 can be drawn together. Once the number of batches 2 corresponding to a palletizable layer have been arranged on the downstream receiving surface 7, the gripping means can be actuated to gather together the products 3 and to form such a layer.

The palletizing device enables each layer of products 3 to be transferred to a pallet in accordance with the predetermined palletization pattern. Such a device transfers the products 3 layer by layer to a pallet such as to create a stack of layers. Such a device can also insert an insert, notably of cardboard or plastic, to separate two successive layers of products 3 on the pallet. In other words, the palletizer arranges the layers of products 3 one after the other on a pallet, ensuring the stability of the stack of layers formed on the pallet.

A palletizer can be provided with a handling arm bearing gripping means used to pick layers of products 3 in order to keep the products close to one another.

The palletizer can then also be used to form the palletizable layers. The palletizer then picks and moves the batches 2 of products 3 to a layer formation module that can work in a manner similar to when the layers are formed directly at the output of the device 1, as described above. The palletizer then picks the layers arranged on the layer formation module and places said layers on a pallet in the manner described above.

According to a possible additional feature, the installation also includes, mounted upstream of said production device 1, a machine delivering the aligned products 3 flowing in a lane 5 in a first direction.

This machine is preferably a bundler or a boxing machine. Such a machine can output a single-lane flow or multi-lane flow of products 3. In each lane 5, the products 3 can be spaced apart from one another, or otherwise. A bundler can output a single-lane flow or multi-lane flow. A boxing machine preferably outputs a single-lane flow.

The invention also relates to a method for producing at least one batch 2 of products 3 having a predetermined configuration from a plurality of products 3, for the purpose of downstream palletizing in layers using the device defined above.

This method is characterized in that it includes at least the following steps:

(i) transferring each product 3 from the upstream acceptance surface 4 onto a shuttle 9 carried by an outbound rail 10, said transfer being effected in the first direction 6,

(ii) moving the shuttles 9 along the at least one outbound rail 10 to the downstream receiving surface 7, independently of one another, changing the relative position of the shuttles 9 to adjust the distance between the products 3 carried thereon and to create in the vicinity of said downstream receiving surface 7 at least one batch 2 of products 3 with a predetermined configuration.

Step (ii) is executed after step (i). Step (i) usually takes place in the upstream transfer zone.

According to a possible additional feature, the method also includes a simultaneous transfer step (iii) of the products 3 forming a batch 2 of products 3 from the shuttles 9 to the downstream receiving surface 7 in a second direction 14 perpendicular to the running direction of the shuttles 9 at this location.

Step (iii) is executed after step (ii) and usually takes place in the downstream transfer zone.

According to an additional possible feature, said shuttles 9 comprise a lower portion that cooperates with a rail 10, 11, 12, 13 and an upper portion that is designed to carry at least one product 3 and, during the movement step (ii) of the shuttles 9, the upper portion of at least one shuttle 9 is rotated about the vertical axis, preferably through an angle of 90°.

Thus, in a one-layer batch 2, at least one of the products 3 can be oriented about the vertical axis differently from at least one other product 3 in the same batch 2.

When the upper portion of a shuttle 9 is rotated through a given angle during step (ii) of the method, said upper portion in principle is rotated through the same angle but in the opposite sense during the subsequent transfer step (iii) to return sane to the initial position. This second rotation can take place when the shuttle 9 is on the downstream lifting rail 13, on the return rail 11 or on the upstream lifting rail 12.

The attached figures show examples of production devices 1 according to different embodiments of the invention.

The products 3 handled by the device 1 are usually cases or bundles containing objects such as bottles, flasks, cans, etc., that are in principle substantially in the form of a rectangular parallelepiped. The objects are preferably arranged along the height of the parallelepiped, i.e. vertically, with the opening thereof towards the top. However, the objects can also be arranged with the openings thereof towards the bottom. The objects are grouped in a rectangular matrix with or without staggering.

There is therefore equipment, for example a bundler or boxing machine, upstream of this production device 1 that groups together and binds the objects to one another in the form of self-supporting bundles or in cases to form the products 3. Thus, this equipment ensures that the products 3 are usually all oriented identically on the acceptance surface 4. In other words, the lengths and widths of the bases of the products 3 are all parallel with one another. For example, as shown in FIGS. 1 to 3, the lengths of the bases of the products 3 can be perpendicular to the first direction 6, i.e. transversal.

Since the machine upstream of the device 1 according to the invention, i.e. notably a boxing machine or a bundler, usually outputs products 3 at regular intervals of time, the products 3 usually arrive spaced apart by the same distance on the upstream acceptance surface 4. However, notably where the upstream machine is a boxing machine, the products 3 may be immediately beside one another when leaving this machine. Furthermore, in certain cases in which the products 3 are spaced apart from one another, the spacing between successive products 3 can be irregular, notably as a result of variations in throughput in the machine upstream of the device 1.

The device 1 is designed to produce the batches 2 of products 3 from the lane or lanes 5 of products 3 using the displacement means 8.

Each batch 2 of products 3 formed using the displacement means 8 includes a set of products 3, i.e. at least two products 3 near one another, and is spaced apart from the previous batch and from the following batch. A batch 2 of products 3 is a set of products 3 that are simultaneously transferred to the downstream receiving surface 7. A batch 2 is a row or partial row of a layer of products 3 on a pallet leaving a palletizing device downstream of the production device 1. A row is typically a succession of products 3 arranged side by side with or without contact between the products extending from one edge of the pallet to the other, and only one product wide. The products in a given batch, and therefore in a given row, are preferably arranged immediately beside one another. In other words, a batch 2 of products 3 is a group of products 3 arranged beside one another, i.e. extending in a single direction, these products 3 usually being arranged immediately beside one another, although a space can also be left between two successive products 3 as a function of the related palletization pattern.

The configuration of the batches 2 is predetermined such that each batch 2 is a row or partial row of a layer of a palletization pattern. The configuration of a batch 2 is defined by the number of products 3 making up the batch, the spacing between these products 3 and the orientation thereof. Two batches 2 can be different from one another. More specifically, the elements that can differ from one batch 2 to another are the number of products, the spacing between the products and the orientation thereof about the vertical axis.

The displacement means 8 comprise at least one outbound rail 10, this outbound rail being associated with a return rail 11, an upstream lifting rail 12 and a downstream lifting rail 13, as described above.

The number of outbound rails 10 in the upstream portion of the displacement means 8 is notably correlated with the number of lanes of products 3 on the upstream acceptance surface 4. The number of outbound rails 10 in the downstream portion of the displacement means 8 is notably correlated with the number of downstream receiving surfaces 7 and/or batches 2 to be positioned simultaneously to form a layer.

As specified above, FIG. 1 shows a device 1 in which the machine arranged upstream of the device 1 outputs products 3 in three parallel lanes 5 extending in the first direction 6. The displacement means 8 then include three outbound rails 10 in the upstream portion thereof, each outbound rail 10 handling the products 3 coming from a different lane 5. The upstream portions of these outbound rails 10 extend in the first direction 6, each extending one of the lanes 5.

FIG. 2 shows a device 1 in which the machine arranged upstream of the device 1 outputs products 3 in a single lane 5 extending in the first direction 6. The displacement means 8 then include a single outbound rail 10 in the upstream portion thereof handling all of the products 3 delivered by the upstream machine. The upstream portion of this outbound rail 10 extends in the first direction 6, extending one of the lanes 5.

FIG. 3 shows a device 1 in which the machine arranged upstream of the device 1 outputs products 3 in two parallel lanes 5 extending in the first direction 6. The displacement means 8 then include two outbound rails 10 in the upstream portion thereof, each outbound rail 10 handling the products 3 coming from one of the lanes 5. The upstream portions of these outbound rails 10 extend in the first direction 6, each extending one of the lanes 5.

Each of the devices 1 shown in FIGS. 1 to 3 has a single downstream receiving surface 7 that is fed with batches 2 of products 3 via two opposing edges thereof using two outbound rails 10. Thus, the displacement means 8 in these three devices 1 have two outbound rails 10 in the downstream portion thereof.

The devices 1 in FIGS. 1 and 2 are then fitted with switches to switch respectively from three to two rails 10 and from one to two rails 10. Conversely, the device in FIG. 3 is provided with two separate outbound rails 10 over the entire length of the displacement means 8. This device therefore has no switches.

In each of the devices 1 shown in FIGS. 1 to 3, the architecture of the return rails 11 is identical to the architecture of the outbound rails 10. More specifically, the structure of the return rails 11 corresponds to the structure of the outbound rails 10 offset vertically downwards.

As specified above:

there are as many upstream lifting rails 12 as outbound rails 10 (and therefore return rails 11) in the upstream portion of the displacement means, and

there are as many downstream lifting rails 13 as outbound rails 10 (and therefore return rails 11) in the downstream portion of the displacement means 8.

Thus, the devices 1 shown in FIGS. 1, 2 and 3 have respectively three, one and two upstream lifting rails 12 and each have two downstream lifting rails 13.

Each of the lifting rails 12, 13 is moveable vertically at least between a high position and a low position. In the high position, the lifting rails 12, 13 are arranged end-to-end with an outbound rail 10 to enable the shuttles 9 to run between the rails 10 and 12, 13. Conversely, in the low position, the lifting rails 12, 13 are arranged end-to-end with a return rail 11 to enable the shuttles 9 to run between the rails 11 and 12, 13. The lifting rails 12, 13 are usually straight and lie in a horizontal plane. More specifically, said rails can extend in the first direction 6 or in a direction perpendicular to the direction 6.

The outbound and return rails 10, 11, at least at the upstream ends thereof, extend in the same direction as the upstream lifting rails 12. The outbound and return rails 10, 11, at least at the downstream ends thereof, extend in the same direction as the downstream lifting rails 13.

In the devices 1 shown in FIGS. 1 to 3, the products 3 are conveyed to the upstream acceptance surface 4 by a conveyor extending in the first direction 6. This conveyor can notably be the output conveyor of the machine upstream of the device 1.

The upstream portion of the upstream acceptance surface 4 is fitted with a system enabling the lanes 5 of products 3 entering this surface 4 transversely to the direction of movement thereof to be spaced apart (or moved together). Thus, the lanes 5 are spaced further apart on the upstream acceptance surface 4 than on the conveyor preceding same. In general, where the bundler is a multi-lane bundler, the center-to-center distance between the products 3 on each track is not variable, and therefore the free space between the lanes 5 of products 3 can vary as a function of the formats of the products 3 handled by the bundler. Such a system then enables the distance between the lanes 5 of products 3 to be adjusted, enabling the products to be received by the shuttles 9 of the outbound rails 10 of the device.

The products 3 are then pushed from behind in the first direction 6 by an upstream transverse pusher (not shown in the figures) as far as the shuttles 9 running on at least one outbound rail 10. In particular, each shuttle 9 carries one product 3.

For this purpose, the shuttles 9 can be synchronized with the arrival of the products 3, for example using a sensor arranged on the upstream transverse pusher.

The shuttles 9 can be moved in a controlled and known manner on the rails 10, 11, 12, 13, which advantageously enables the position of the products 3 moved by the shuttles to be known precisely and at all times. For this purpose, the movement of the shuttles 10 is driven by a magnetic linear motor principle, which has the advantage of managing and controlling the position and the speed of each shuttle separately. The device 1 according to the invention thus enables the spacing between two successive products 3 to be controlled precisely.

The speeds of the shuttles 9 carrying a product 3 are then adapted individually to move successive products 3 towards or away from one another to form the batches 2 of products 3 at the downstream ends of the outbound rails 10. The upper portions of the shuttles 9 can also be rotated, notably through an angle of 90°, in order to change the orientation of the products 3 carried thereby to form the batches 2 in the desired configuration.

In the attached figures, the downstream ends of the outbound rails 10 extend in the first direction 6 and run along two opposite edges of the downstream receiving surface 7. The batches 2 formed at the downstream end of each outbound rail 10 therefore also run along two opposite edges of the downstream receiving surface 7. The two batches 2 are then transferred, notably simultaneously, to the downstream receiving surface 7 by two downstream transverse pushers 15 that extend in the same direction as the batches 2 being transferred.

Each downstream transverse pusher 15 pushes a batch 2 of products 3 simultaneously onto the downstream receiving surface 7 in the second direction 14 perpendicular to the direction of the batch 2 on the outbound rail 10, therefore perpendicular to the first direction 6 in the attached drawings. Thus, the two pushers 15 push the batches 2 in the direction 14, but in the opposite sense to convey the batches 2 onto the downstream receiving surface 7.

Once a batch 2 has been transferred, the shuttles 9 that were carrying the products 3 making up this batch 2 continue moving empty on the related outbound rail 10 to the downstream end of the displacement means 8 to be transferred to a return rail 11 via a downstream lifting rail 13. The downstream lifting rail 13 associated with this outbound rail 10 (and with the return rail 11 arranged beneath this outbound rail 10) is then in the high position and therefore arranged end-to-end with the outbound rail 10. The empty shuttles 9 can then run to the downstream lifting rail 13.

The downstream lifting rail 13 can then switch to the low position and therefore be arranged end-to-end with the associated return rail 11. The shuttles 9 on the downstream lifting rail 13 can then run towards the upstream portion of the displacement means 8. The shuttles then reach the return rail 11.

Naturally, the shuttles 9 used to form a batch 2 of products 3 are not necessarily transferred simultaneously from an outbound rail 10 to a return rail 11. The shuttles can for example be transferred individually or in groups of any number of shuttles 9.

The transfer of shuttles 9 from a return rail 11 to an outbound rail 10 associated therewith, i.e. positioned above said outbound rail at the upstream end of the displacement means 8, is executed in the same way as the transfer from an outbound rail 10 to a return rail 11, but using an upstream lifting rail 12. The upstream lifting rails 12 are usually straight and extend in the first direction 6.

For this purpose, an upstream lifting rail 12 is first switched to the low position so as to be arranged end-to-end with the associated return rail 11. The rail then receives at least one shuttle 9 from the return rail 11, then executes a vertical translational movement to switch to the high position and to be arranged end-to-end with the associated outbound rail 10. The at least one shuttle 10 then runs in the first direction 6 to reach the outbound rail 10, then receives at least one product 3.

As detailed above, there are usually a palletizable-layer formation device and a palletizing device downstream of the device 1.

The invention makes it possible to provide a solution for forming batches 2 of products 3 that have a predetermined configuration for palletizing that is versatile and reliable, and that limits the risk of damaging products due to the implementation thereof involving limited relative movement between the products 3 and the supports thereof. Furthermore, the proposed solution occupies limited floor space and enables an operator to interact easily with the device 1.

Although the description above is based on specific embodiments, this in no way limits the scope of the invention and modifications may be made, notably by means of technical equivalent substitutes or different combinations of all or some of the features discussed above.

1. A device (1) for producing hatches (2) of products (3) from a plurality of products (3), said batches (2) having a predefined configuration for palletizing in layers downstream, said device (I) comprising an upstream acceptance surface (4) on which the products (3) are aligned in a lane (5) in a first direction (6), a downstream receiving surface (7) for receiving the batches (2), and displacement means (8) between the two surfaces (4, 7) that is formed by a series of rails and by a plurality of shuttles (9) that can move independently of one another and that run on said rails, each shuttle (9) configured to carry at least one product (3), wherein
the series of rails has at least one outbound rail (10) configured to move the products (3) coming from the upstream surface (4) to the downstream surface (7), a return rail (11) arranged beneath the outbound rail (10) configured to return the empty shuttles (9) to the upstream surface (4), and an upstream lifting rail (12) and a downstream lifting rail (13) configured to transfer the empty shuttles (9) between the outbound and return rails (10, 11).
and in that these lifting rails (12, 13) usually lie in a horizontal plane and are configured to effect at least one vertical translational movement between two positions, namely a high position and a low position; the high position entailing a lifting rail (12, 13) being arranged end-to-end with the outbound rail (10) and the low position entailing a lifting rail (12, 13) being arranged end-to-end with the return rail (11).

2. The device as claimed in claim 1, wherein said shuttles (9) comprise a lower portion that cooperates with a rail (10, 11, 12, 13) and an upper portion configured to carry at least one product (3), in which the upper portions of said shuttles (9) can undergo, preferably independently of each other, a rotation about the vertical axis, preferably through an angle of 90°.

3. The device as claimed in claim 2, wherein at least one shuttle (9) carries a rotation system enabling the upper portion thereof to rotate about the vertical axis.

4. The device as claimed in claim 2, further comprising at least one element arranged outside said shuttles (9), this element being configured to rotate the upper portion of at least one shuttle (9) about the vertical axis.

5. The device as claimed in claim 1, wherein the series of rails is formed by a plurality of outbound rails (10), independent or otherwise, and of return rails (11), in which the architecture of the outbound and return rails (10, 11) is similar and there are as many upstream lifting rails (12) as outbound flow paths at the upstream end of the displacement means (8), and as many downstream lifting rails (13) as outbound flow paths at the downstream end of the displacement means (8).

6. The device as claimed in claim 5, wherein the series of rails is such that there are:
between one and five, and notably between one and three, outbound flow paths at the upstream end of the displacement means (8),
between one and two outbound flow paths at the downstream end of the displacement means (8),
wherein there is the same number of outbound and return flow paths at each of the downstream and upstream ends of the displacement means (8).

7. The device as claimed in claim 1, further comprising an upstream transverse pusher that is configured to transfer the products (3) in the first direction (6) from the upstream acceptance surface (4) onto the shuttles (9) of the at least one outbound rail (10).

8. The device as claimed in claim 1, wherein the upstream acceptance surface (4) is carried by an upstream conveyor extending in the first direction (6), and in that the upper surface of said shuttles (9) running on the at least one outbound rail (10) is offset vertically downwards in relation to the surface (4) carrying the products (3) such that the products (3) drop onto the shuttles (9) as a result of the movement of said upstream conveyor.

9. The device as claimed in claim 1, further comprising a gripping means configured to pick the batches (2) of products (3) on the shuttles (9) of the at least one outbound rail (10) and to transfer same to the downstream receiving surface (7) in a second direction (14) perpendicular to the running direction of the shuttles (9) at this location.

10. The device as claimed in claim 1, further comprising a downstream transverse pusher (15) configured to transfer the batches (2) of products (3) on the shuttles (9) of the at least one outbound rail (10) to the downstream receiving surface (7) in a second direction (14) perpendicular to the running direction of the shuttles (9) at this location.

11. The device as claimed in claim 1, wherein the downstream receiving surface (7) is carried by a downstream conveyor configured to move the batches (2) of products (3) in a third direction that is preferably parallel or perpendicular to the transfer direction (14) of the batches (2) of products (3) from the shuttle (9) onto the downstream receiving surface (7).

12. An installation including a device (1) for producing batches (2) of products (3) as claimed in claim 1, further comprising mounted downstream of said production device (1), a device for forming palletizable layers from batches (2) of products (3) and a palletizing device for stacking the palletizable layers on a pallet.

13. The installation as claimed in claim 12, further comprising, mounted upstream of said production device (1), a machine delivering the aligned products (3) flowing in a lane (5) in a first direction (6), in which said machine can notably be a bundler or a boxing machine.

14. A method for producing at least one batch (2) of products (3) that has a predetermined configuration based on a plurality of products (3), with a view to palletizing in layers carried out downstream, using the device as defined according to any claim 1, the method comprising:
(i) transferring each product (3) from the upstream acceptance surface (4) onto a shuttle (9) carried by an outbound rail (10), said transfer being effected in the first direction (6),
(ii) moving the shuttles (9) along the at least one outbound rail (10) to the downstream receiving surface (7), independently of one another, changing the relative position of the shuttles (9) to adjust the distance between the products (3) carried thereon and to create in the vicinity of said downstream receiving surface (7) at least one batch (2) of products (3) with a predetermined configuration.

15. The method as claimed in claim 14, further comprising a simultaneous transfer step (iii) of the products (3) forming a batch (2) of products (3) from the shuttles (9) to the downstream receiving surface (7) in a second direction (14) perpendicular to the running direction of the shuttles (9) at this location.

16. The method as claimed in claim 14, wherein said shuttles (9) comprise a lower portion that cooperates with a rail (10, 11, 12, 13) and an upper portion configured to carry at least one product (3), and in that during the movement step (ii) of the shuttles (9), the upper portion of at least one shuttle (9) is rotated about the vertical axis, preferably through an angle of 90°.
